(19) United States
(12) Patent Application Publication
(10) Pub. No.: US 2017/0074235 A1
(43) Pub. Date: Mar. 16, 2017

(54) HYDRAULIC ROTATING MACHINE

(71) Applicant: KYB Corporation, Tokyo (JP)

(72) Inventors: Kaori SUGIMOTO, Tokyo (JP); Hiroshi ARIJI, Kanagawa (JP)

(73) Assignee: KYB Corporation, Tokyo (JP)

(21) Appl. No.: 15/123,475

(22) PCT Filed: Jan. 23, 2015
(86) PCT No.: PCT/JP2015/051897

§ 371 Date: Sep. 2, 2016

(30) Foreign Application Priority Data
Mar. 28, 2014 (JP) 2014-068754

(51) Int. Cl. F03C 1/32; F04B 53/14; F04B 1/20

(52) U.S. Cl. CPC F03C 1/0652; F04B 1/2035; F04B 53/14

(57) ABSTRACT

A hydraulic rotating machine adapted to be actuated and rotated by supply and discharge of a working fluid includes a cylinder block to which a shaft is coupled, the cylinder block being configured to be rotate together with the shaft; a cylinder formed to have an opening portion on one end side of the cylinder block, a recessed portion being formed on an inner circumference of the cylinder; and a bush inserted from the opening portion of the cylinder and provided on the inside of the cylinder, the bush having a projection portion filled into the recessed portion by plastic deformation. The recessed portion is formed in such a manner that width along an axial direction of the cylinder becomes smaller toward the depth direction.

### TECHNICAL FIELD

The present invention relates to a hydraulic rotating machine adapted to be actuated and rotated by supply and discharge of a working fluid such as a piston pump and a piston motor.

### BACKGROUND ART

As conventional hydraulic rotating machine, there is a known hydraulic rotating machine that has a thin and tubular bush provided in a cylinder formed in a cylinder block in order to improve seize resistance and wear resistance of a sliding surface of a piston.

There is a need for fixing such a bush so that the bush is not detached from the cylinder even when the piston slides on the inside of the bush. JP1997-264305A discloses a hydraulic rotating machine in which a recessed portion is provided on an inner wall of a cylinder, a bush is press-fitted into the cylinder and then pushed out from the inside and plastically deformed, and the bush is attached by embedding an outer circumference of the bush into the recessed portion of the cylinder.

### SUMMARY OF INVENTION

In the hydraulic rotating machine disclosed in JP1997-264305A, the recessed portion of the cylinder is formed in such a manner that corner parts are formed at right angle and depth of a bottom surface is constant in the axial direction.

In a case where the bush is plastically deformed and filled into such a recessed portion, the bush does not sufficiently flow into peripheries of the corner parts in the recessed portion and there is a fear that an underfill part is generated. When the underfill part of the bush is generated in the corner part of the recessed portion on the side of an opening portion of the cylinder, a function of the bush filled into the recessed portion as a detachment stopper becomes insufficient.

An object of the present invention is to improve a detachment stopping performance of a bush provided in a cylinder of a hydraulic rotating machine.

According to one aspect of the present invention, a hydraulic rotating machine adapted to be actuated and rotated by supply and discharge of a working fluid includes a cylinder block to which a shaft is coupled, the cylinder block being configured to be rotate together with the shaft; a cylinder formed to have an opening portion on one end side of the cylinder block, a recessed portion being formed on an inner circumference of the cylinder; and a bush inserted from the opening portion of the cylinder and provided on the inside of the cylinder, the bush having a projection portion filled into the recessed portion by plastic deformation. The recessed portion is formed in such a manner that width along an axial direction of the cylinder becomes smaller toward the depth direction.

### BRIEF DESCRIPTION OF DRAWINGS

FIG. 1 is a sectional view of a hydraulic rotating machine according to an embodiment of the present invention.

FIG. 2 is an enlarged view of an A part in FIG. 1, showing a shape of a recessed portion.

FIG. 3 is an enlarged view of a cylinder in the hydraulic rotating machine according to the embodiment of the present invention, showing a state before a bush is filled into the recessed portion.

FIG. 4 is a sectional view showing a modified example of the shape of the recessed portion in the hydraulic rotating machine according to the embodiment of the present invention.

FIG. 5 is a sectional view showing a modified example of the shape of the recessed portion in the hydraulic rotating machine according to the embodiment of the present invention.

FIG. 6 is a sectional view showing a modified example of the shape of the recessed portion in the hydraulic rotating machine according to the embodiment of the present invention.

FIG. 7 is a sectional view showing a modified example of the shape of the recessed portion in the hydraulic rotating machine according to the embodiment of the present invention.

FIG. 8 is a sectional view showing a modified example of the shape of the recessed portion in the hydraulic rotating machine according to the embodiment of the present invention.

FIG. 9 is a sectional view showing a modified example of the shape of the recessed portion in the hydraulic rotating machine according to the embodiment of the present invention.

FIG. 10 is a sectional view showing a shape of a recessed portion in a hydraulic rotating machine according to a comparative example of the embodiment of the present invention.

### DESCRIPTION OF EMBODIMENTS

Hereinafter, an embodiment of the present invention will be described with reference to the drawings.

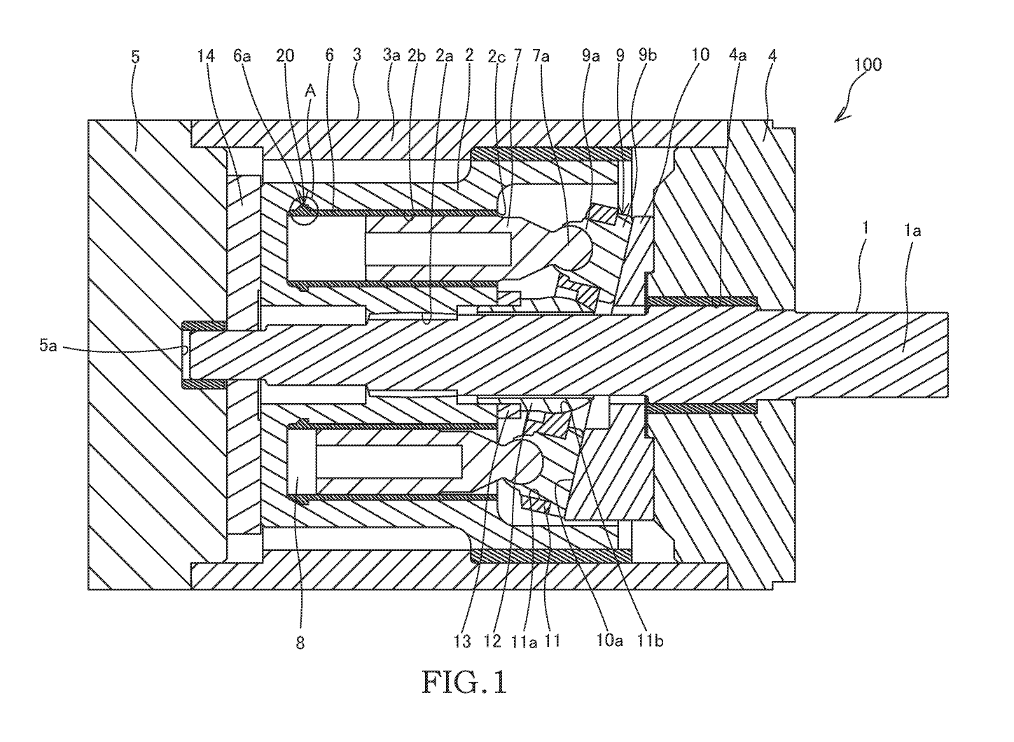

With reference to FIG. 1, a hydraulic rotating machine according to the embodiment of the present invention will be described.

In the present embodiment, a case where the hydraulic rotating machine is a swash plate type axial piston pump/motor 100 in which working oil serves as a working fluid will be described. The swash plate type axial piston pump/motor 100 functions as a pump which supplies the working oil serving as the working fluid when a shaft 1 is rotated by power from an exterior so that pistons 7 reciprocate. The swash plate type axial piston pump/motor 100 functions as a motor capable of outputting rotation drive force when the pistons 7 reciprocate by fluid pressure of the working oil supplied from the exterior so that the shaft 1 is rotated.

In the following description, a case where the swash plate type axial piston pump/motor 100 is used as a piston pump will be exemplified, and the swash plate type axial piston pump/motor 100 will be simply called as the “piston pump 100”.

Firstly, with reference to FIG. 1, the entire structure of the piston pump 100 will be described.

The piston pump 100 includes the shaft 1 to be rotated by a power source, a cylinder block 2 coupled to the shaft 1 to be rotated together with the shaft 1, and a case 3 accommodating the cylinder block 2. The case 3 includes a case main body 3a whose both ends are opened, a front cover 4 through which the shaft 1 is inserted and which seals one of the opened ends of the case main body 3a, and an end cover 5 sealing the other opened end of the case main body 3a and accommodating an end part of the shaft 1.

One end part 1a of the shaft 1 projecting to the exterior through an insertion hole 4a of the front cover 4 is coupled to the power source. The other end part of the shaft 1 is accommodated in an accommodation recessed portion 5a provided in the end cover 5 and rotatably supported.

The cylinder block 2 has a through hole 2a through which the shaft 1 passes, and the shaft 1 is spline-coupled to the through hole 2a. Thereby, the cylinder block 2 is rotated in accordance with rotation of the shaft 1.

In the cylinder block 2, a plurality of cylinders 2b each of which has an opening portion 2c on one end surface is formed in parallel to the shaft 1. The plurality of cylinders 2b is formed at predetermined intervals in the circumferential direction of the cylinder block 2.

An annular groove 20 serving as a recessed portion is formed on an inner circumference of each of the cylinders 2b to extend in the circumferential direction. The annular groove 20 may be formed over the entire circumference in the circumferential direction of the cylinder 2b or may be formed in a part in the circumferential direction. The recessed portion may be formed not as an annular groove but may be formed as a dent (so-called dimple shape).

A thin and tubular bush 6 is inserted from the opening portion 2c of the cylinder 2b and provided on the inside of the cylinder 2b. A projection portion 6a in which a part of the bush 6 is filled into the annular groove 20 by plastic deformation is formed on an outer circumference of the bush 6. That is, the projection portion 6a is formed on the outer circumference of the bush 6 as an annular projection. By forming the projection portion 6a in the annular groove 20 of the cylinder 2b, the bush 6 is locked onto the cylinder 2b. Therefore, the projection portion 6a of the bush 6 and the annular groove 20 of the cylinder 2b function as a retainer for preventing detachment of the bush 6 from the cylinder 2b.

The columnar piston 7 is inserted into the cylinder 2b so as to slide on an inner circumference of the bush 6. The piston 7 partitions a capacity chamber 8 inside the cylinder 2b. A leading end side of the piston 7 projects from the opening portion 2c of the cylinder 2b, and a spherical base 7a is formed in a leading end part thereof.

A shoe 9 is rotatably coupled to the spherical base 7a of the piston 7. The shoe 9 includes a receiving portion 9a that receives the spherical base 7a formed in a leading end of the piston 7, and a circular flat plate portion 9b. An inner surface of the receiving portion 9a is formed in a spherical shape and brought into sliding contact with an outer surface of the received spherical base 7a. Thereby, an angle of the shoe 9 with respect to the spherical base 7a can be changed.

The piston pump 100 further includes a swash plate 10 arranged in the case 3 and fixed to an inner wall of the front cover 4, a retainer plate 11 that retains all the shoes 9, a retainer holder 12 to be brought into sliding contact with the retainer plate 11, and a spring 13 placed between the retainer holder 12 and the cylinder block 2 in a compressed state.

The swash plate 10 has a sliding contact surface 10a inclined with respect to the direction perpendicular to an axis of the shaft 1. The flat plate portions 9b of the shoes 9 are brought into surface contact with the sliding contact surface 10a.

The retainer plate 11 is formed as a ring shape flat plate member. The retainer plate 11 has a plurality of insertion bores 11a formed at predetermined intervals in the circumferential direction. The retainer plate 11 retains all the shoes 9 provided in the leading ends of the pistons 7 on the same plane in a state where the receiving portions 9a of the shoes 9 are inserted into the insertion bores 11a.

The retainer holder 12 is a tubular member which is installed on an outer circumference of the shaft 1 so as to be capable of sliding in the axial direction along the shaft 1. The retainer holder 12 is arranged in such a manner that an outer circumferential surface of a leading end side thereof is brought into sliding contact with an inner circumferential surface of a center hole 11b of the retainer plate 11.

The spring 13 is a bias member that biases the retainer holder 12 to the side of the retainer plate 11. When the retainer holder 12 biased in such a way presses the retainer plate 11 to the side of the swash plate 10, the shoes 9 are pushed onto the swash plate 10.

The piston pump 100 further includes a valve plate 14 placed between the cylinder block 2 and the end cover 5.

The valve plate 14 is a disc member with which a base end surface of the cylinder block 2 is brought into sliding contact, and fixed to the end cover 5. A suction port (not shown) connecting a suction passage (not shown) formed in the end cover 5 and the capacity chambers 8, and a discharge port (not shown) connecting a discharge passage (not shown) formed in the end cover 5 and the capacity chambers 8 are formed in the valve plate 14.

Next, actions of the piston pump 100 will be described.

When the shaft 1 is driven and rotated by the power from the exterior and the cylinder block 2 is rotated, the flat plate portions 9b of the shoes 9 slide on the swash plate 10, and the pistons 7 reciprocate in the cylinders 2b by a stroke amount in accordance with a tilting angle of the swash plate 10. By reciprocation of the pistons 7, capacities of the capacity chambers 8 are increased or decreased.

The working oil is guided to the capacity chambers 8 enlarged by rotation of the cylinder block 2 through the suction passage of the end cover 5 and the suction port of the valve plate 14. The working oil suctioned into the capacity chambers 8 is pressurized by contraction of the capacity chambers 8 due to the rotation of the cylinder block 2, and the working oil is discharged through the discharge port of the valve plate 14 and the discharge passage of the end cover 5. In such a way, in the piston pump 100, suction and discharge of the working oil are continuously performed in accordance with the rotation of the cylinder block 2.

Next, a detachment stopper structure of the bush 6 of the piston pump 100 will be described in detail.

As shown in FIG. 1, the annular groove 20 is formed at a position out of a range where the piston 7 slides in the axial direction in the cylinder 2b. That is, the annular groove 20 is formed at an axial position on the bottom side of the cylinder 2b with respect to an end surface of the piston 7 in a state where the capacity chamber 8 in the cylinder 2b is reduced to be the smallest.

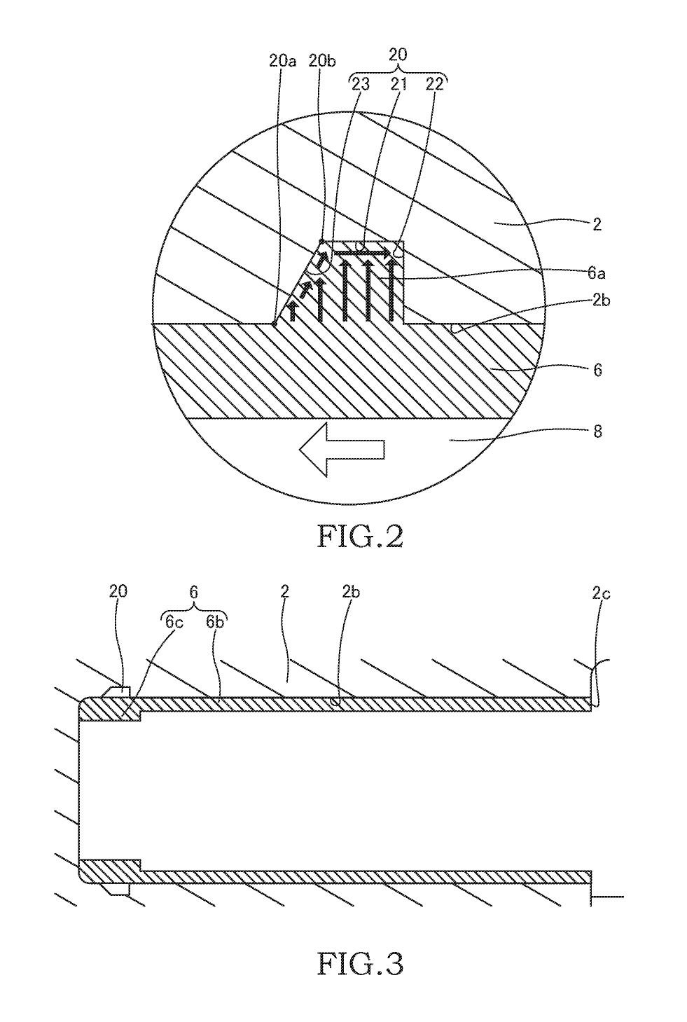

As shown in FIG. 2, an inner wall of the annular groove 20 has a groove bottom portion 21 serving as a bottom of the annular groove 20, a regulating portion (second side surface portion) 22 that regulates the detachment of the bush 6 from the cylinder 2b, and a facing portion (first side surface portion) 23 formed to face the regulating portion 22.

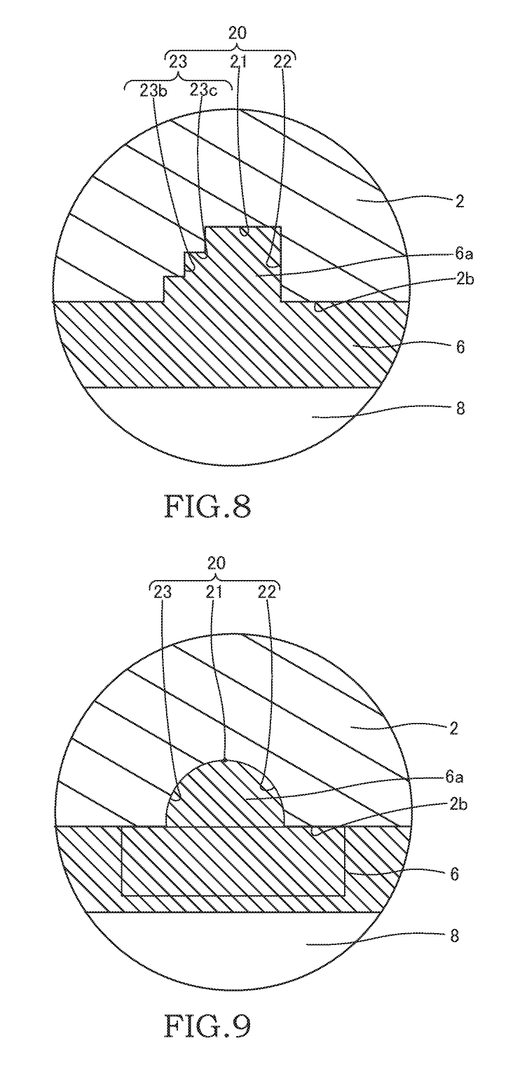

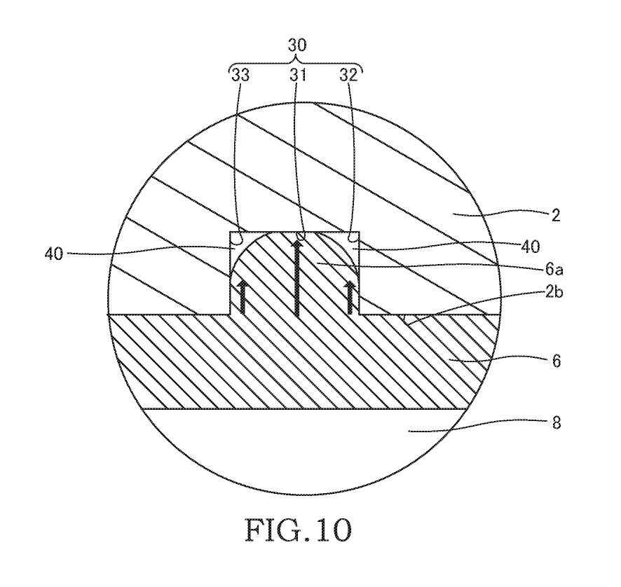

The groove bottom portion 21 of the annular groove 20 is a part that defines depth of the annular groove 20. The groove bottom portion 21 is formed as a cylindrical surface about an axis of the annular groove 20. That is, as shown in FIG. 2, a sectional shape of the groove bottom portion 21 along the axial direction is formed to extend in parallel to the axis. The groove bottom portion 21 may be not formed in a cylindrical surface shape. For example, as in a modified example of the annular groove 20 shown in FIG. 9 to be described later, the groove bottom portion 21 may be formed in a linear shape or may be a point as in a case where the recessed portion is formed as a dent (so-called dimple shape).

The regulating portion 22 of the annular groove 20 is a side surface portion formed on an opening-side, which is formed from the side of the opening portion 2c of the cylinder 2b toward the groove bottom portion 21 of the annular groove 20. In other words, the regulating portion 22 is a side part on the front side in the direction in which the bush 6 is detached from the cylinder 2b among side parts of the annular groove 20, that is, the side part on the rear side in the direction in which the bush 6 is inserted into the cylinder 2b (white arrow direction in FIG. 2). The regulating portion 22 is provided as a vertical surface perpendicular to the axis of the annular groove 20. The regulating portion 22 of the annular groove 20 and the projection portion 6a of the bush 6 are locked onto each other. Thus, even when force in the direction of detaching from the cylinder 2b is applied to the bush 6, the detachment of the bush 6 from the cylinder 2b is regulated by the regulating portion 22. In such a way, the regulating portion 22 of the annular groove 20 functions as a detachment stopper that regulates the detachment of the bush 6 from the cylinder 2b.

The facing portion 23 of the annular groove 20 is a side surface portion on the bottom part side (i.e. an opposite side of the opening portion 2c of the cylinder 2 with respect to the groove bottom portion 21 of the annular groove 20), which is formed from the bottom part side of the cylinder 2b toward the groove bottom portion 21. That is, the facing portion 23 is a side part on the front side in the direction in which the bush 6 is inserted into the cylinder 2b among the side parts of the annular groove 20. The facing portion 23 is a tapered portion formed in an inclined shape with respect to the direction perpendicular to the axis of the annular groove 20 in such a manner that depth becomes greater toward the groove bottom portion 21. In such a way, a boundary 20a between an inner circumferential surface of the cylinder 2b and the facing portion 23 is provided on the opposite side (bottom part side of the cylinder 2b) of the opening portion 2c of the cylinder 2b with respect to a boundary 20b between the facing portion 23 and the groove bottom portion 21.

As described above, the annular groove 20 is formed in such a manner that width along the axial direction of the cylinder 2b becomes smaller toward the depth direction.

Next, a method of forming the projection portion 6a by inserting the bush 6 into the cylinder 2b and then filling a part of the bush 6 into the annular groove 20 of the cylinder 2b will be described.

An outer diameter of the bush 6 before attached to the cylinder 2b is formed to be larger than an inner diameter of the cylinder 2b. By press-fitting such a bush 6 into the cylinder 2b, the bush 6 is attached to the cylinder 2b.

The projection portion 6a of the bush 6 is formed by plastically deforming the bush 6 by a tube expanding step of pushing out the bush from the inside and filling a part of the bush 6 inside the annular groove 20.

FIG. 3 is an enlarged view of the cylinder 2b showing a state where the bush 6 is press-fitted into the cylinder 2b before the bush 6 is expanded. As shown in FIG. 3, the bush 6 before expanded is formed in a stepped shape having a thin portion 6b and a thick portion 6c formed to be thick on the inner diameter side in comparison with the thin portion 6b. Such a bush 6 is press-fitted into the cylinder 2b in such a manner that the thick portion 6c is placed on the bottom part side of the cylinder 2b.

After the bush 6 is press-fitted into the cylinder 2b, only the thick portion 6c is pushed out from the inside by using an expanding tool and plastically deformed. The plastically deformed bush 6 flows in the direction perpendicular to the axial direction, and is filled into the annular groove 20 formed on the inside of the cylinder 2b. In such a way, by filling a part of the bush 6 into the annular groove 20 of the cylinder 2b by plastic deformation, the projection portion 6a of the bush 6 is formed.

In order to facilitate understanding of the retaining structure of the bush 6, as a comparative example, an annular groove 30 whose sectional shape is square having right-angled corner parts as shown in FIG. 10 will be described.

An inner wall of the annular groove 30 has a bottom surface 31 parallel to the axis, and vertical surfaces 32, 33 perpendicular to the axis.

When the bush 6 is plastically deformed by the tube expanding step in order to fill a part of the bush 6 into the annular groove 30, the bush 6 flows in the direction perpendicular to the axis as shown by arrows in FIG. 10.

Friction is generated between a part of the bush 6 filled into the annular groove 30 and the vertical surfaces 32, 33 of the annular groove 30. Due to such friction, filling of the bush 6 becomes insufficient in peripheries of the right-angled corner parts of the annular groove 30. Therefore, there is a fear that underfill parts 40 are generated in the corner parts of the projection portion 6a of the bush 6 formed by plastic deformation in the tube expanding step. When the underfill parts 40 are generated in the corner parts of the projection portion 6a, a contact area between the vertical surface 32 of the annular groove 30 and the projection portion 6a is reduced. Therefore, the annular groove 30 does not sufficiently exert the function as the detachment stopper of the bush 6.

Meanwhile, the facing portion 23 of the annular groove 20 in the piston pump 100 is a tapered portion formed in an inclined shape with respect to the direction perpendicular to the axis of the annular groove 20. Therefore, as shown in FIG. 2, when a part of the bush 6 is filled into the annular groove 20, the bush 6 brought into contact with the facing portion 23 after flowing in the direction perpendicular to the axis flows in the axial direction toward the regulating portion 22.

In such a way, in a periphery of the regulating portion 22, a part of the bush 6 is filled by a material flow from the axial direction in addition to a material flow from the direction perpendicular to the axis. Therefore, the bush 6 is sufficiently filled into the corner part between the regulating portion 22 and the groove bottom portion 21, so that generation of an underfill part can be prevented in the projection portion 6a of the bush 6. Thereby, a contact area between the regulating portion 22 and the projection portion 6a of the bush 6 is increased. Thus, the function of the annular groove 20 as the detachment stopper can be improved.

When the thick portion 6c of the bush 6 is expanded and plastically deformed from the inside, there is a fear that the bush 6 also flows in the axial direction and expands to the inner side of the thin portion 6b of the bush 6. However, the annular groove 20 of the piston pump 100 is formed out of a range of an axial position where the piston 7 slides in the cylinder 2b. Therefore, even when the thick portion 6c of the bush 6 expands to the inner side of the thin portion 6b by plastic deformation of the bush 6 by expanding, sliding of the piston 7 is not prevented and the piston 7 can slide smoothly. In other words, the annular groove 20 is preferably formed at such a position that sliding of the piston 7 is not prevented even when the bush 6 is plastically deformed by expanding.

According to the above embodiment, the following effects will be exerted.

In the piston pump 100, the width of the annular groove 20 along the axial direction of the cylinder 2b is formed to become smaller toward the depth direction of the annular groove 20. Therefore, when the bush 6 is expanded from the inside and plastically deformed for filling the bush 6 into the annular groove 20 and forming the projection portion 6a, the bush 6 is filled in the peripheries of the corner parts on the bottom side in which the width is smaller in the annular groove 20 by the material flow from the axial direction in addition to the material flow from the direction perpendicular to the axis. Thus, in the corner part of the annular groove 20 on the side of the opening portion 2c of the cylinder 2b, generation of an underfill part can be prevented in the projection portion 6a of the bush 6. Therefore, a detachment stopping performance of the bush 6 can be improved.

The facing portion 23 of the annular groove 20 formed on the inner circumference of the cylinder 2b is formed as such a tapered portion that the depth becomes greater toward the groove bottom portion 21. Therefore, when the bush 6 is expanded from the inside and plastically deformed for filling the bush 6 into the annular groove 20, the bush 6 brought into contact with the facing portion 23 flows in the axial direction from the facing portion 23 toward the regulating portion 22 on the side of the opening portion 2c of the cylinder 2b. Thus, in the periphery of the regulating portion 22, the bush 6 is filled by the material flow from the axial direction in addition to the material flow from the direction perpendicular to the axis. Therefore, in the periphery of the regulating portion 22 in the annular groove 20, generation of an underfill part of the bush 6 can be prevented, so that the detachment stopping performance of the bush 6 can be improved.

The annular groove 20 is formed on the bottom side of the cylinder 2b with respect to the end surface of the piston 7 in a state where the capacity chamber 8 is reduced to be the smallest. Therefore, even though the bush 6 is plastically deformed so that a part of the bush 6 is filled into the annular groove 20, inside deformation of a part of the bush 6 within a range where the piston 7 slides in the axial direction can be prevented. In such a way, even when the bush 6 is plastically deformed, sliding of the piston 7 is not prevented. Thus, the piston 7 can slide smoothly.

Next, modified examples of the piston pump 100 according to the present embodiment will be described.

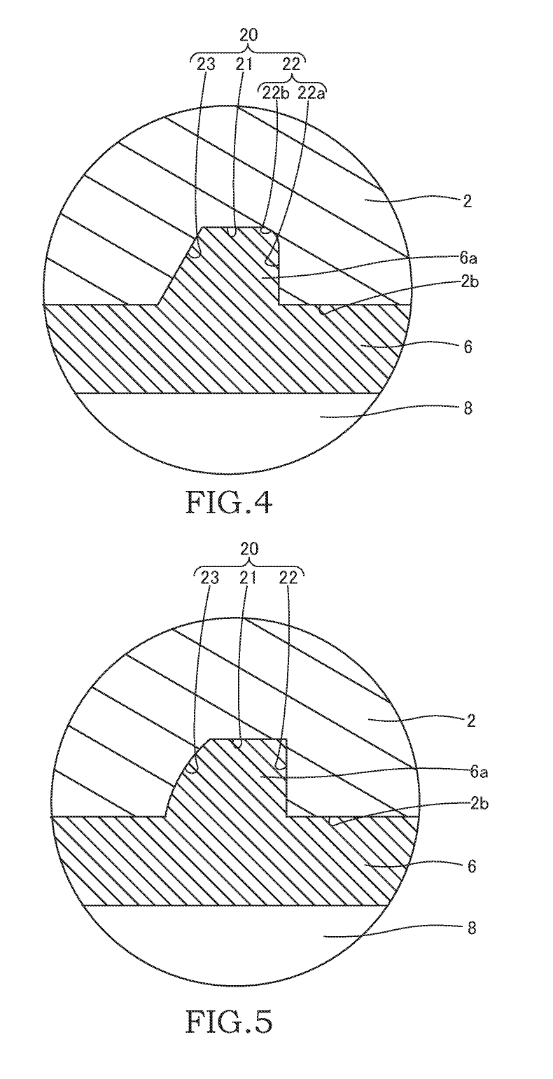

In the above embodiment, the regulating portion 22 of the annular groove 20 is formed only by a vertical surface perpendicular to the axis of the cylinder 2b. Instead of this, as shown in FIG. 4, the regulating portion 22 may have a first vertical portion 22a serving as a vertical surface perpendicular to the axis, and a first curved surface portion 22b formed in a curved surface shape and formed continuously to the groove bottom portion 21. In such a way, since the corner part of the annular groove 20 on the side of the regulating portion 22 serves as the first curved surface portion 22b, the bush 6 is more easily filled into the corner part of the annular groove 20. Therefore, even when the annular groove 20 is formed to be deeper, the bush 6 can be filled into the corner part of the annular groove 20. That is, since the corner part of the annular groove 20 on the side of the regulating portion 22 serves as the first curved surface portion 22b, the depth of the annular groove 20 can be greater. Thus, the function as the detachment stopper can be further improved.

The regulating portion 22 may not have a vertical surface perpendicular to the axis of the cylinder 2b. That is, the regulating portion 22 may be formed in an inclined shape or a curved surface shape in such a manner that the depth becomes greater toward the groove bottom portion 21. In this case, the facing portion 23 may be formed only by a vertical surface perpendicular to the axis of the cylinder 2b. That is, in such a case, when the bush 6 is expanded from the inside and plastically deformed for filling the bush 6 into the annular groove 20, the bush 6 brought into contact with the regulating portion 22 flows in the axial direction along the regulating portion 22 and in the direction perpendicular to the axis. Therefore, the bush 6 is filled in the periphery of the corner part between the groove bottom portion 21 and the regulating portion 22 by the material flow from the axial direction along the regulating portion 22 in addition to the material flow from the direction perpendicular to the axis. Thus, in the periphery of the regulating portion 22 in the annular groove 20, generation of an underfill part of the bush 6 can be prevented, so that the detachment stopping performance of the bush 6 can be improved.

In the above embodiment, the facing portion 23 of the annular groove 20 is a tapered portion formed in an inclined shape with respect to the direction perpendicular to the axis of the cylinder 2b. Instead of this, as shown in FIG. 5, the facing portion 23 may have a second curved surface portion formed in a curved surface shape. The facing portion 23 may be formed only by the second curved surface portion as shown in FIG. 5 or a part of the facing portion 23 may have the second curved surface portion.

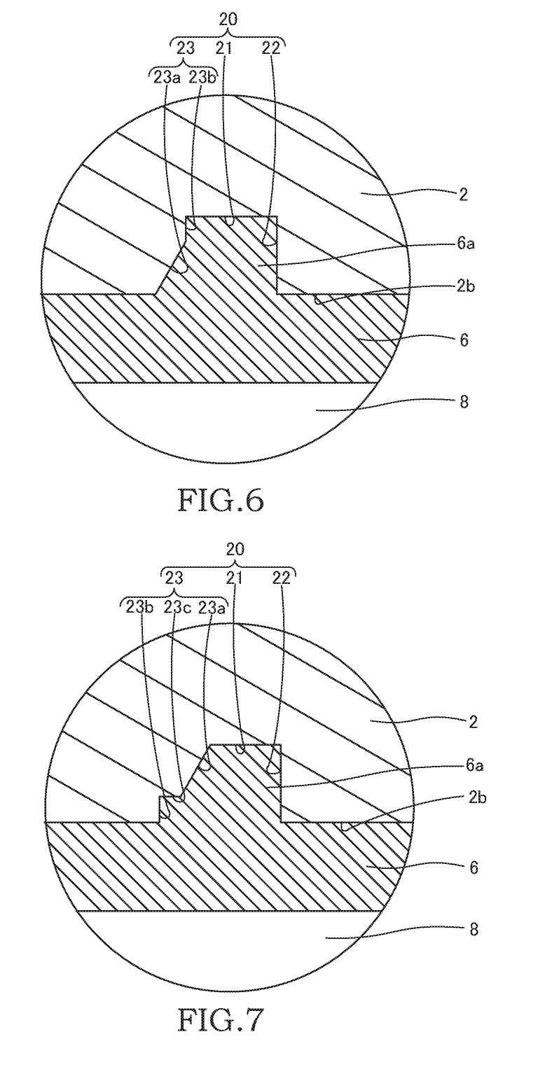

As shown in FIGS. 6 and 7, the facing portion 23 may have a second vertical portion 23b formed perpendicularly to the axis. The facing portion 23 may be formed by the second vertical portion 23b and a tapered portion 23a as in FIG. 6, or may further have a cylindrical portion 23c in which a portion along the axis is parallel to the axis in addition to the second vertical portion 23b and the tapered portion 23a as in FIG. 7.

As shown in FIG. 8, the facing portion 23 may be formed in a stepped shape by the second vertical portion 23b formed perpendicularly to the axis and the cylindrical portion 23c parallel to the axis. In this case, the bush 6 flowing into the annular groove 20 on the side of the facing portion 23 is brought into contact with the cylindrical portion 23c before the bush 6 on the side of the regulating portion 22 is brought into contact with the groove bottom portion 21. Since the cylindrical portion 23c is connected to the second vertical portion 23b on the opposite side of the regulating portion 22, the bush 6 brought into contact with the cylindrical portion 23c mainly flows in the axial direction toward the regulating portion 22. Therefore, the bush 6 is more easily filled into the facing portion 23 formed in a stepped shape than into the right-angled corner part, and the bush 6 can be proportionately moved to flow toward the regulating portion 22. Thus, the same effects as the above embodiment can be exerted.

As shown in FIG. 9, the regulating portion 22 and the facing portion 23 may be formed in an arc shape to form a continuous curved surface shape. In this case, the deepest position of the arc surface serves as the groove bottom portion 21.

As described above, an inner wall shape of the annular groove 20 can be arbitrarily formed as long as the width along the axial direction of the cylinder 2b becomes smaller toward the depth direction. That is, the inner wall shape of the annular groove 20 may be arbitrarily formed in such a manner that a desired retaining performance can be exerted in accordance with the inner diameter of the cylinder 2b, the stroke amount of the piston 7, and the like. Since the annular groove 20 is formed in such a manner that the width along the axial direction of the cylinder 2b becomes smaller toward the depth direction, an underfill part of the projection portion 6a of the bush 6 is prevented in the periphery of the corner part between the regulating portion 22 and the groove bottom portion 21. Thus, the same effects as the above embodiment can be exerted.

Embodiments of this invention were described above, but the above embodiments are merely examples of applications of this invention, and the technical scope of this invention is not limited to the specific constitutions of the above embodiments.

In the above embodiment, the working oil is used as the working fluid. However, instead of this, for example, a soluble replacement solution or the like may be used.

In the above embodiment, the case where the hydraulic rotating machine is the swash plate type axial piston pump/motor 100 is described. However, other piston pump or piston motor including a cylinder and a piston may be used.

In the above embodiment, only one annular groove 20 is formed on the inner circumference of the cylinder 2b. However, the plurality of annular grooves may be formed side by side in the axial direction of the cylinder 2b or the annular groove may be formed in a spiral shape about the axis of the cylinder 2b.

In the above embodiment, the outer diameter of the bush 6 is formed to be larger than the inner diameter of the cylinder 2b, and the bush is press-fitted into the cylinder 2b. In order to prevent the detachment of the bush 6, the bush is preferably press-fitted. However, the bush 6 may be provided on the inside of the cylinder 2b by a method other than press-fitting. In this case, the detachment stopping function of the bush 6 is exerted only by a part of the bush 6 filled into the annular groove 20.

This application claims priority based on Japanese Patent Application No. 2014-68754 filed with the Japan Patent Office on Mar. 28, 2014, the entire contents of which are incorporated into this specification.

1. A hydraulic rotating machine adapted to be actuated and rotated by supply and discharge of a working fluid, comprising:
a cylinder block to which a shaft is coupled, the cylinder block being configured to be rotate together with the shaft;
a cylinder formed to have an opening portion on one end side of the cylinder block, a recessed portion being formed on an inner circumference of the cylinder; and
a bush inserted from the opening portion of the cylinder and provided on the inside of the cylinder, the bush having a projection portion filled into the recessed portion by plastic deformation, wherein
the recessed portion is formed in such a manner that width along an axial direction of the cylinder becomes smaller toward the depth direction.

2. The hydraulic rotating machine according to claim 1, wherein
the recessed portion is formed in an annular shape on an inner circumference of the cylinder.

3. The hydraulic rotating machine according to claim 1, wherein
the recessed portion has a first side surface portion formed from an opposite side to the opening portion of the cylinder toward a bottom of the recessed portion, and
a boundary between an inner circumferential surface of the cylinder and the first side surface portion is provided on the opposite side of the opening portion of the cylinder with respect to a boundary between the first side surface portion and the bottom of the recessed portion.

4. The hydraulic rotating machine according to claim 3, wherein
the first side surface portion is formed in an inclined shape.

5. The hydraulic rotating machine according to claim 3, wherein
the first side surface portion is formed in a stepped shape.

6. The hydraulic rotating machine according to claim 3, wherein
the first side surface portion is formed in a curved surface shape.

7. The hydraulic rotating machine according to claim 1, wherein
the recessed portion has a second side surface portion formed from a side of the opening portion of the cylinder toward a bottom of the recessed portion, and
at least a part of the second side surface portion is formed perpendicularly to an axis of the cylinder.

8. The hydraulic rotating machine according to claim 1, further comprising:
a piston inserted slidably on an inner circumference of the bush, wherein
the recessed portion is formed out of a range where the piston slides in an axial direction.
